(19) United States
(12) Patent Application Publication
(10) Pub. No.: US 2025/0106356 A1
(43) Pub. Date: Mar. 27, 2025

(54) AUGMENTING ENVIRONMENTAL AUDIO BASED ON VIDEO CHARACTERISTICS

(71) Applicant: Apple Inc., Cupertino, CA (US)

(72) Inventors: Luis R. DELIZ CENTENO, Fremont, CA (US); Ronald J. GUGLIELMONE, JR., Redwood City, CA (US); Devin W. CHALMERS, Oakland, CA (US)

(21) Appl. No.: 18/895,300

(22) Filed: Sep. 24, 2024

Related U.S. Application Data
(60) Provisional application No. 63/585,835, filed on Sep. 27, 2023.

(51) Int. Cl. H04N 7/14

(52) U.S. Cl. CPC H04N 7/147

(57) ABSTRACT

Some examples of the disclosure are directed to systems and methods for augmenting and/or minimizing environment audio based on video characteristics associated with a video communication session facilitated by a video communications application. The video characteristics include activation of an outward facing camera. In response to detecting the activation of an outward facing camera, an electronic device augments an environment audio stream associated with the video communication session and attenuates a first person audio stream associated with the video communication session such that the user listening to the audio stream hears audio that has the environmental audio emphasized while the first person audio is deemphasized. In response to detecting the activation of an inward facing camera, the device emphasizes the first person audio stream and deemphasizes the environmental audio stream.

### CROSS-REFERENCE TO RELATED APPLICATIONS

This application claims the benefit of U.S. Provisional Application No. 63/585,835, filed Sep. 27, 2023, the content of which is herein incorporated by reference in its entirety for all purposes.

### FIELD OF THE DISCLOSURE

This relates generally to the presentation of audio during a video communication session taking place on an electronic device.

### BACKGROUND OF THE DISCLOSURE

Some electronic devices include an application to facilitate a video communication session between the user of the device and another user using another device. Audio is presented by the device in a manner that promotes efficient communications between the users.

### SUMMARY OF THE DISCLOSURE

Some examples of the disclosure are directed to systems and methods for augmenting and/or minimizing/reducing environment audio based on video characteristics associated with a video communication session facilitated by a video communications application. In one or more examples, the video characteristics include activation of an outward facing camera. In response to detecting the activation of an outward facing camera, an electronic device augments an environment audio stream associated with the video communication session and attenuates a first person audio stream associated with the video communication session such that the user listening to the audio stream hears audio that has the environmental audio emphasized while the first person audio is deemphasized so that the user listening to the audio stream is able to efficiently hear the environmental audio with minimal interference from the first person audio stream. In one or more examples, and in response to detecting the activation of an inward facing camera, the device emphasizes (e.g., augments) the first person audio stream and deemphasizes the environmental audio stream such that the user of the electronic device is able to efficiently hear the first person audio stream with minimal interference caused by the environment audio stream. By augmenting and/or minimizing first person audio and environmental audio based on the characteristics of a video, the video communications session becomes more efficient and the user experience improves since the audio that the user of an electronic device is hearing is more closely tied to the video that is being displayed during a video communication session.

In one or more examples, the video characteristics described above can include detection of an object of interest in the received video stream associated with a participant of the video communication session. In some examples, in response to detecting the object of interest, one or more electronic devices can modify a directionality parameter associated with the received audio stream, such that the environment audio has a directionality imparted onto it that is commensurate with the location of the object of interest within a given video stream.

Enhancing the presentation of the audio based on circumstances associated with the video communication session improves the user's experience with the device and decreases user interaction time, which is particularly important where the computer system and/or input devices are battery operated. The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a device according to some examples of the disclosure.

FIG. 3 illustrates an example system for implementing video communications according to examples of the disclosure.

FIGS. 4A-D illustrate example audio models for presenting audio in a video communications session according to examples of the disclosure.

FIG. 5 illustrates an example flow diagram illustrating a method of presenting audio during a video communications session according to examples of the disclosure.

### DETAILED DESCRIPTION

Some examples of the disclosure are directed to systems and methods for augmenting and/or minimizing environment audio based on video characteristics associated with a video communication session facilitated by a video communications application. In one or more examples, the video characteristics include activation of an outward facing camera (or selection of an outward facing camera for the video data stream). In response to detecting the activation of an outward facing camera, an electronic device augments an environment audio stream associated with the video communication session and/or attenuates a first person audio stream associated with the video communication session such that the user listening to the audio stream hears audio that has the environmental audio emphasized while the first person audio is deemphasized so that the user listening to the audio stream is able to efficiently hear the environmental audio with minimal interference from the first person audio stream. In some examples, augmenting either of the environmental audio or first person audio includes transitioning the audio from an attenuated state to an unaltered state, and transitioning the audio from an unaltered state to an enhanced state. In one or more examples, deemphasizing the first-person audio or the environmental audio includes transitioning the audio from and enhanced state to an unaltered state, and transitioning the audio from an unaltered state to an attenuated state. In one or more examples, and in response to detecting the activation of an inward facing camera (or selection of an inward facing camera for the video data stream), the device emphasizes (e.g., augments) the first person audio stream and deemphasizes the environmental audio stream such that the user of the electronic device is able to efficiently hear the first person audio stream with minimal interference caused by the environment audio stream. In one or more examples, activation of an inward facing camera causes filtering of the environmental audio (e.g., to enable focus on the first person audio), whereas activation of an outward facing camera causes forgoing filtering of the environment audio.

In one or more examples, the video characteristics described above can include detection of an object of interest in the received video stream associated with a participant of the video communication session. In some examples, in response to detecting the object of interest, one or more electronic devices can modify a directionality parameter associated with the received audio stream, such that the environment audio has a directionality imparted onto it that is commensurate with the location of the object of interest within a given video stream.

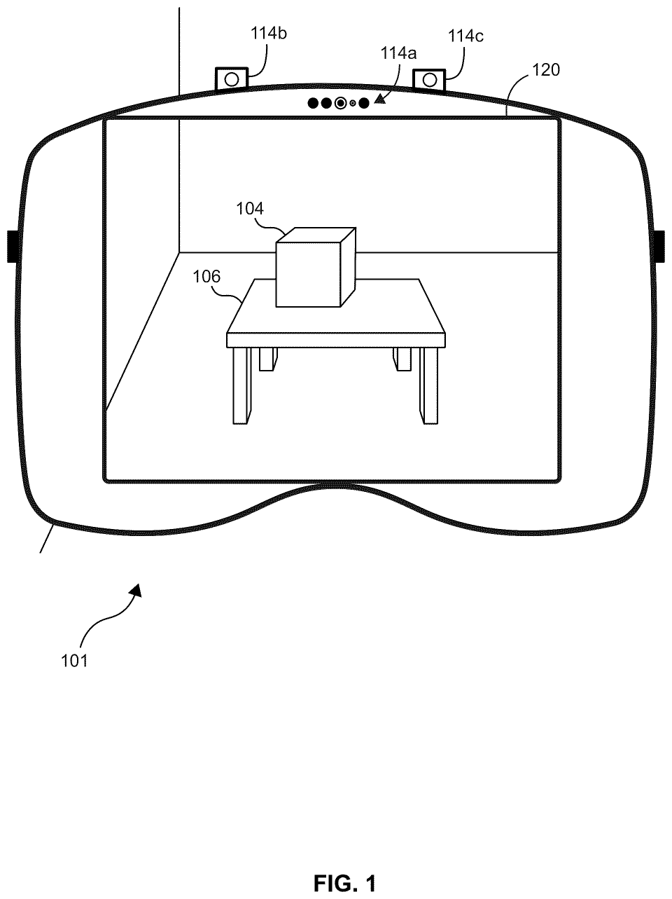

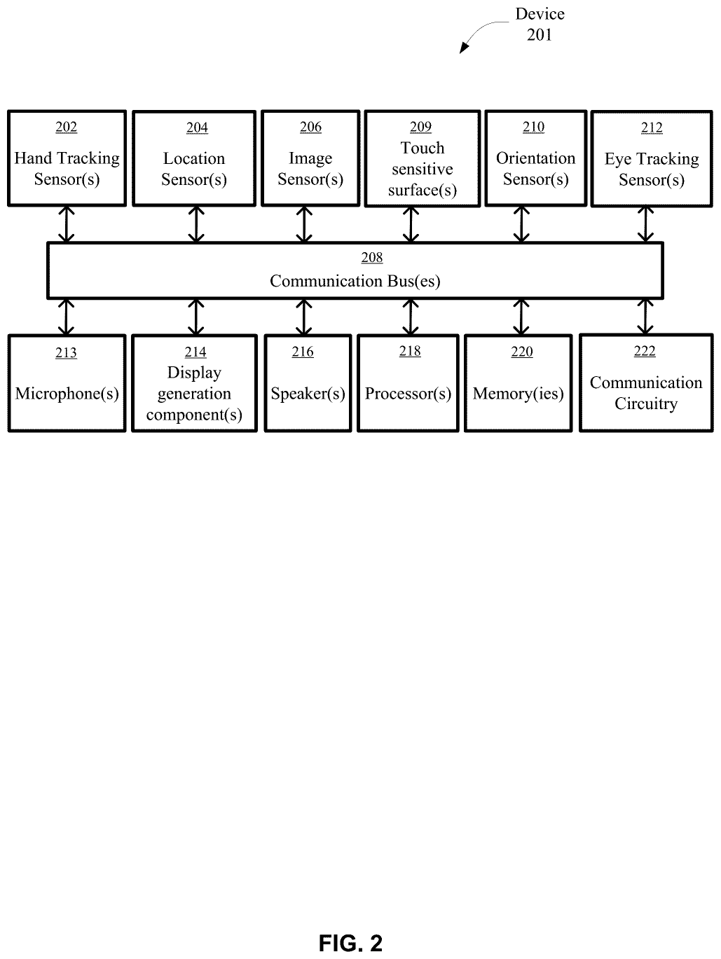

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101 that includes one or more displays. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device (or one or more input devices) in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for a device 201 according to some examples of the disclosure. In some examples, device 201 includes one or more electronic devices. For example, the electronic device 201 may be a portable device, an auxiliary device in communication with another device, a head-mounted display, etc., respectively. In some examples, electronic device 201 corresponds to electronic device 101 described above with reference to FIG. 1.

As illustrated in FIG. 2, the electronic device 201 optionally includes various sensors, such as one or more hand tracking sensors 202, one or more location sensors 204, one or more image sensors 206 (optionally corresponding to internal image sensors 114a and/or external image sensors 114b and 114c in FIG. 1), one or more touch-sensitive surfaces 209, one or more motion and/or orientation sensors 210, one or more eye tracking sensors 212, one or more microphones 213 or other audio sensors, one or more body tracking sensors (e.g., torso and/or head tracking sensors), one or more display generation components 214, optionally corresponding to display 120 in FIG. 1, one or more speakers 216, one or more processors 218, one or more memories 220, and/or communication circuitry 222. One or more communication buses 208 are optionally used for communication between the above-mentioned components of electronic devices 201.

Communication circuitry 222 optionally includes circuitry for communicating with electronic devices, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth®.

Processor(s) 218 include one or more general processors, one or more graphics processors, and/or one or more digital signal processors. In some examples, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some examples, memory 220 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214 include a single display (e.g., a liquid-crystal display (LCD), organic light-emitting diode (OLED), or other types of display). In some examples, display generation component(s) 214 includes multiple displays. In some examples, display generation component(s) 214 can include a display with touch capability (e.g., a touch screen), a projector, a holographic projector, a retinal projector, a transparent or translucent display, etc. In some examples, electronic device 201 includes touch-sensitive surface(s) 209, respectively, for receiving user inputs, such as tap inputs and swipe inputs or other gestures. In some examples, display generation component(s) 214 and touch-sensitive surface(s) 209 form touch-sensitive display(s) (e.g., a touch screen integrated with electronic device 201 or external to electronic device 201 that is in communication with electronic device 201).

Electronic device 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from electronic device 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201 uses CCD sensors, event cameras, and depth sensors in combination to detect the physical environment around electronic device 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201 uses image sensor(s) 206 to detect the position and orientation of electronic device 201 and/or display generation component(s) 214 in the real-world environment. For example, electronic device 201 uses image sensor(s) 206 to track the position and orientation of display generation component(s) 214 relative to one or more fixed objects in the real-world environment.

In some examples, electronic device 201 includes microphone(s) 213 or other audio sensors. Electronic device 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Electronic device 201 includes location sensor(s) 204 for detecting a location of electronic device 201 and/or display generation component(s) 214. For example, location sensor(s) 204 can include a global positioning system (GPS) receiver that receives data from one or more satellites and allows electronic device 201 to determine the device's absolute position in the physical world.

Electronic device 201 includes orientation sensor(s) 210 for detecting orientation and/or movement of electronic device 201 and/or display generation component(s) 214. For example, electronic device 201 uses orientation sensor(s) 210 to track changes in the position and/or orientation of electronic device 201 and/or display generation component(s) 214, such as with respect to physical objects in the real-world environment. Orientation sensor(s) 210 optionally include one or more gyroscopes and/or one or more accelerometers.

Electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some examples, hand tracking sensor(s) 202 and/or eye tracking sensor(s) 212 are implemented together with the display generation component(s) 214. In some examples, the hand tracking sensor(s) 202 and/or eye tracking sensor(s) 212 are implemented separate from the display generation component(s) 214.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more body parts (e.g., a hand, leg, torso, or head of a human user). In some examples, the hands can be resolved with sufficient resolution to distinguish fingers and their respective positions. In some examples, one or more image sensors 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 201 is not limited to the components and configuration of FIG. 2, but can include fewer, other, or additional components in multiple configurations. In some examples, electronic device 201 can be implemented between two electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201, is optionally referred to herein as a user or users of the device.

Attention is now directed towards interactions with one or more virtual objects that are displayed in a three-dimensional environment presented at an electronic device (e.g., corresponding to electronic device 201), and specifically, interactions with a video communications session occurring in a three-dimensional environment.

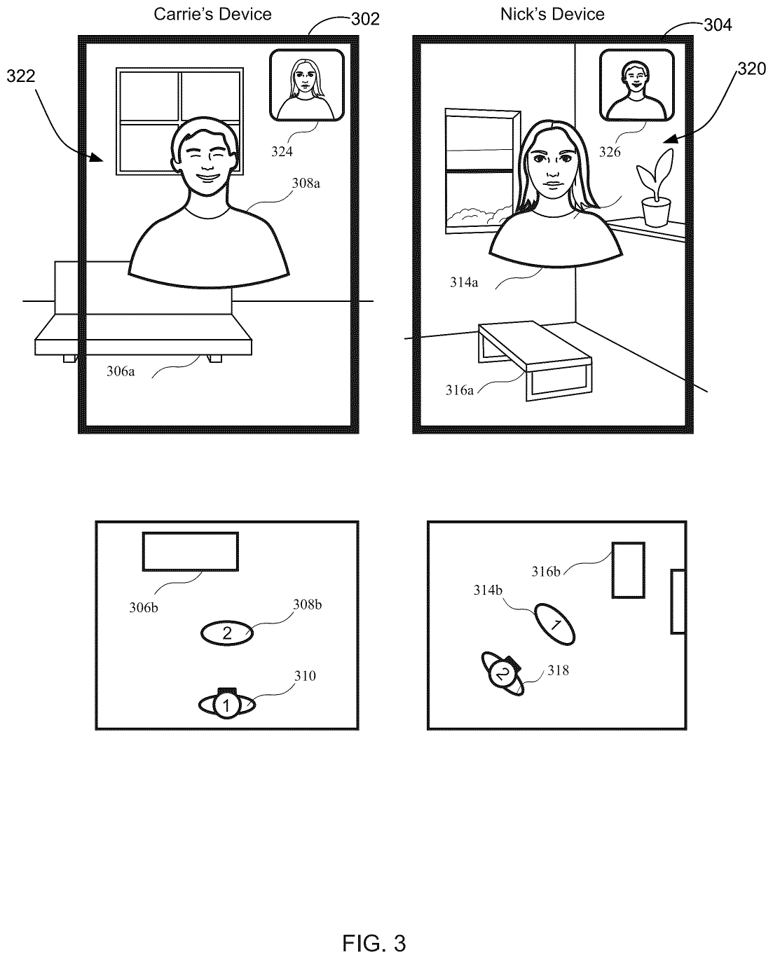

FIG. 3 illustrates an example system for implementing video communications according to examples of the disclosure. In one or more examples of the disclosure, the electronic device described above can facilitate a video communications session via a video communications application that is stored on and executed by the device. In one or more examples, a video communications session can refer to a communication session between two or more users, each of whom are using their own separate devices (e.g., each corresponding to an electronic device described above with respect to FIGS. 1-2, but optionally each including more or fewer components) to communicate with one another using both audio and video. For instance, as illustrated in FIG. 3, two users (e.g., Nick and Carrie) communicate with one another using their own separate devices, with each device including a video communications application that is stored and executed on each of device 302 (e.g., Carrie's device) and device 304 (e.g., Nick's device).

The example of FIG. 3 simultaneously illustrates the video communication session from the perspectives of device 302 and device 304. From the perspective of device 302 (e.g., Carrie's device), the device presents via a display generation component (e.g., display 120 of FIG. 1) a three-dimensional environment 322 from a viewpoint of user 310 (e.g., facing the back wall of the physical environment in which computer system is located, as shown in the overhead view of the three-dimensional environment 322). As shown in FIG. 3, the device 302 (e.g., Carrie's device) captures one or more images of the physical environment around the device 302 including one or more objects in the physical environment around the device. In some examples, device 302 displays representations of the physical environment in three-dimensional environment 322. For example, three-dimensional environment 322 includes a representation 306a of a sofa (corresponding to sofa 306b in the overhead view of three-dimensional environment 322), which is optionally a representation of a physical sofa in the physical environment. The examples described throughout are described with respect to a video communications session using one or more devices that present video in a three-dimensional environment (e.g., extended reality devices), however the examples should not be seen as limiting and could be applied to a video communications session using one or devices that present video in a two dimensional environment. Furthermore, the video displayed in a two-dimensional environment could be in the form of video captured from a transmitting device rather than a spatial or avatar representation. Additionally or alternatively, the video displayed in a two-dimensional environment could be presented on an optical see-through device in which views of the physical environment are viewed directly through a transparent or translucent display.

In one or more examples, and as device 302 is engaged in a video communications session with device 304 (e.g., Nick's device), device 302 displays an avatar 308a of the user of device 304 (corresponding to avatar 308b in the overhead view of three-dimensional environment 322) or other visual representation of the user of device 304. As will be described in further detail below, within the context of a video communications session, device 302 receives video and audio associated with the user with whom they are communicating. In one or more examples, device 302 receives both video and audio from device 304. The video and audio are captured by device 304 using one or more cameras (e.g., corresponding to image sensor(s) 206) and one or more microphones (e.g., corresponding to microphone(s) 213) that are part of the device 304. Thus, in one or more examples, device 302 receives both video and audio data from device 304, which device 302 then uses to display an avatar 308a or other video stream and present audio (e.g., emit sound using speakers) based on the received audio data, thereby facilitating communications between the user 318 of device 304 and user 310 of device 302. In the example of FIG. 3, based on the video data transmitted by device 304 to device 302, device 302 displays an avatar 308a that represents the user 318 of device 304, and specifically based on video data captured by one or more cameras of device 304. However, as described in further detail below, the visual representation used during the video communications session can change based on changes to video initiated by user 318 of device 304, for instance in response to the user 318 activating one or more cameras of device 304 or switching to one or more different cameras of device 304. Additionally or alternatively, device 302 optionally displays a thumbnail image/video 324 that represents what user 318 of device 304 will see displayed on device 304 based on the video data transmitted device 302 (or alternatively displays an avatar 314b or other visual representation of user 310).

In one or more examples, and as part of a two-way video communications session, device 304 (e.g., Nick's device) can receive audio and video from device 302 (e.g., Carrie's device) and use the received video and audio to generate a representation of the user of device 302 within three-dimensional environment 320, and present/output audio based on the audio received from device 302. As shown in FIG. 3, device 304 (e.g., Nick's device) captures one or more images of the physical environment around the device 304 including one or more objects in the physical environment around the device. In some examples, device 304 displays representations of the physical environment in three-dimensional environment 320. For example, three-dimensional environment 320 includes a representation 316a of a coffee table (corresponding to coffee table 316b in the overhead view of three-dimensional environment 320), which is optionally a representation of a physical coffee table in the physical environment.

In one or more examples, and as device 304 is engaged in a video communications session with device 302 (e.g., Carrie's device), device 304 displays an avatar 314a (corresponding to avatar 314b in the overhead view of three-dimensional environment 320). As will be described in further detail below, within the context of a video communications session, device 304 receives video and audio associated with the user with whom they are communicating. Additionally and optionally, device 304 displays a thumbnail image/video 326 that represents what user 310 of device 302 will see displayed on device 302 based on the video data transmitted by device 304. In one or more examples, device 304 receives both video and audio from device 302. The video and audio are captured by device 302 using one or more cameras and microphones that are part of the device. Thus, in one or more examples, device 304 receives both video and audio data from device 302, which it then uses to display an avatar 314a and emit audio based on the received audio data thereby facilitating communications between the user 318 of device 304 and user 310 of device 302. In the example of FIG. 3, based on the video data transmitted by device 302 to device 304, device 304 displays an avatar 314a that represents the user 310 of device 302, and specifically based on video data captured by one or more cameras of device 302. However, as described in further detail below, the visual representation used during the video communications session can change based on changes to video initiated by user 310 of device 302 for instance in response to the user 310 activating one or more cameras of device 302.

In some examples, the audio recorded by a device as part of a video communication session like the one described above with respect to FIG. 3 can be processed in accordance with a state of the video data being recorded by the device in order to facilitate efficient communications between two devices. As described in detail below, the device can respond to detected changes in video by making corresponding changes to the audio to enhance the user experience both users in a video communication session.

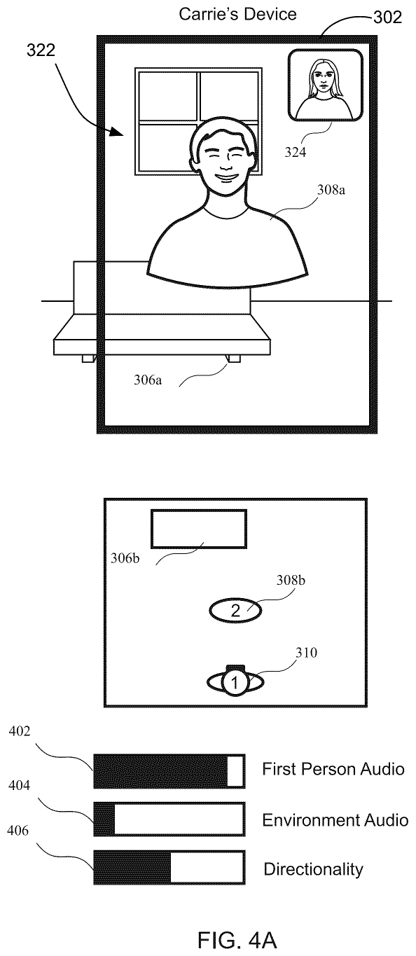

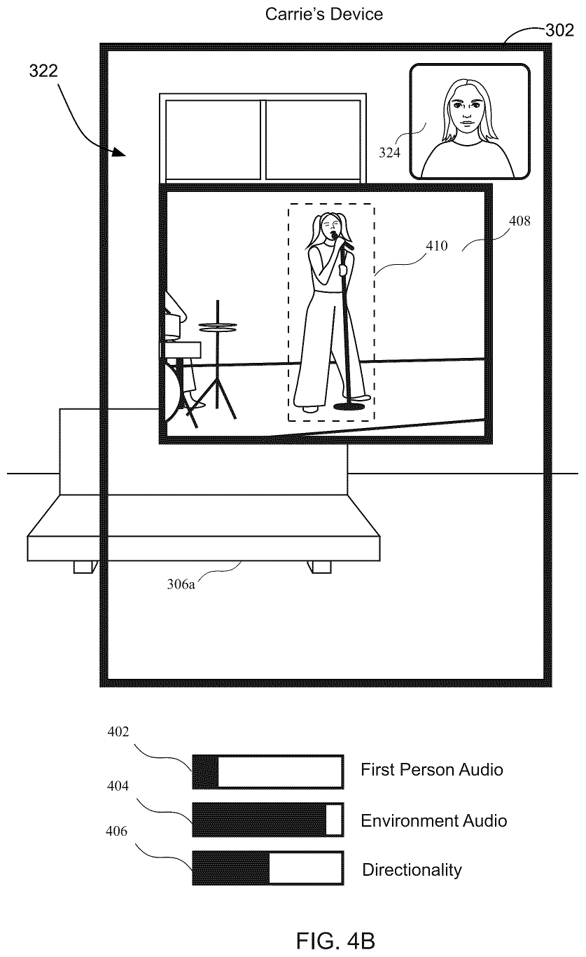

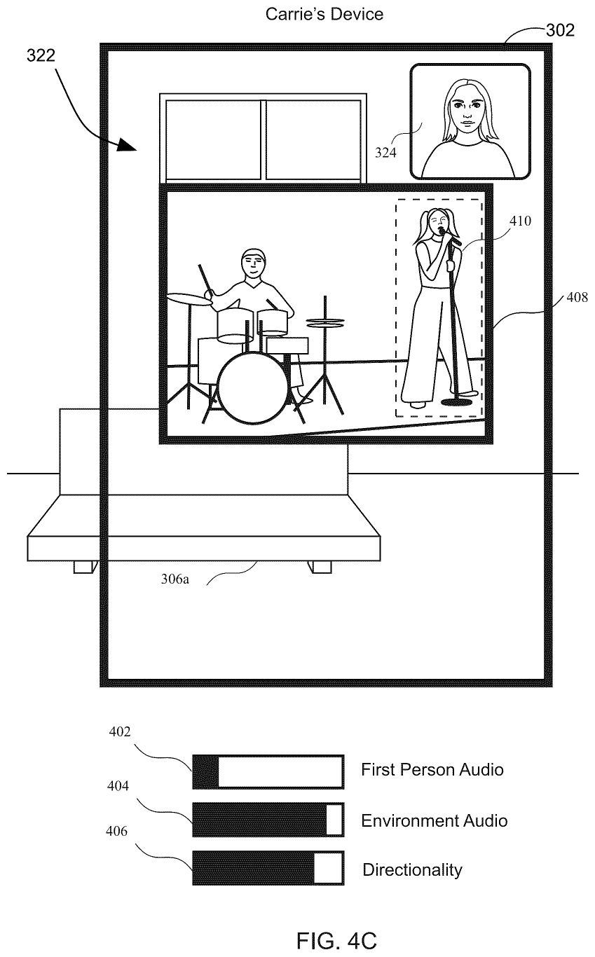

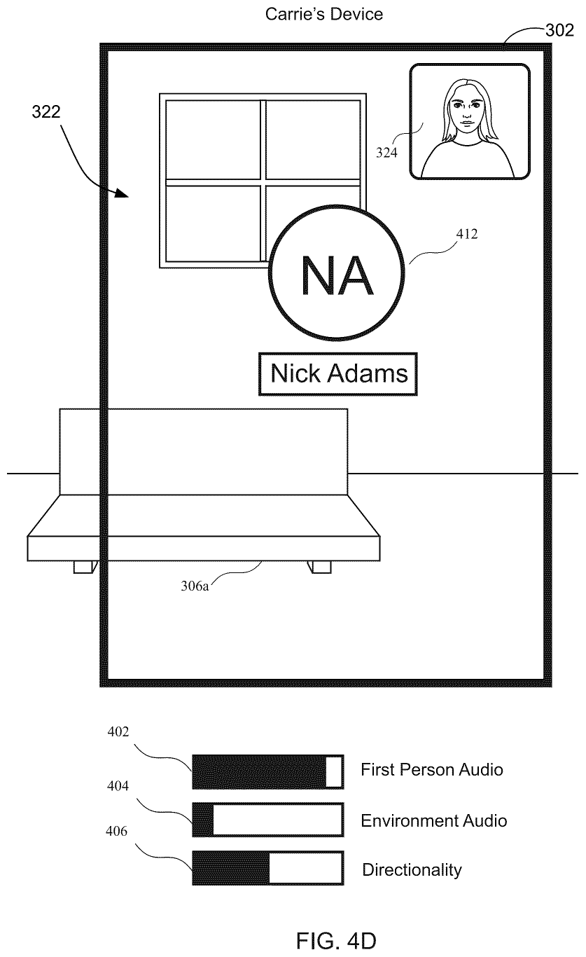

FIGS. 4A-D illustrate example audio models for presenting audio in a video communications session according to examples of the disclosure. FIG. 4A illustrates the video communication session described above with respect to FIG. 3, from the perspective of device 302 (e.g., from Carrie's device). Thus, in one or more examples, the user of device 302 is in a video communication session with another user (such as user 318 of device 304 in FIG. 3). In one or more examples, device 302 receives video data and audio data from the device 304 (either directly or through a server or some other computer system) that device 302 is engaged with for the purposes of facilitating the video communications session. With respect to the video data, in some examples, device 302 can receive raw video data (e.g., unprocessed) from the other device 304, and then optionally process the data to generate avatar 308a. Optionally, instead of an avatar, the device can display the real-time video data provided by the transmitting device as described above. Additionally or alternatively, the device 304 that transmits the video data can send processed video data (e.g., an avatar). For instance, device 302 can receive processed video data from the transmitting device 304, wherein the processed video data has been processed to be in the form of an avatar. In the event that the data received from the transmitting device is already processed to be in the form of an avatar, then device 302 displays the received data as avatar 308a with no or little processing (e.g., no need to extract the avatar data). In one or more examples, avatar 308a is representation of user 318 with body or other facial expressions based on camera data (e.g., video data) collected from the transmitting device (e.g., the image sensors described above). As discussed above, in some examples the camera data can be processed at the collecting device before being transmitted to render an avatar, and the avatar data is then sent to device 302. Alternatively or additionally, the collecting device transmits the raw image sensor data (or data that has been minimally processed) and device 302 processes the camera data so as to render avatar 308a.

In one or more examples, the audio data associated with avatar 308a received from the device 304 engaged in a video communications session with device 302, can optionally be captured and processed at the device 304 and transmitted to device 302 and/or optionally transmitted to device 302 as raw audio and then processed at device 302. Thus, in one or more examples, when the audio is being referred to as being “generated” and/or “processed” it should be understood by those of skill in the art that generation and/or processing can be performed at either the transmitting device or the receiving device (or at an intermediate device or computer system, such as a server). As discussed below, the audio associated with a video communication session can be generated according to an audio model based on the video data that is associated with the audio, which are both associated with a video communications session. The audio can be “generated” (e.g., processed prior to being emitted at a speaker) at either the transmitting device and/or the receiving device as described above.

In one or more examples, the audio can be generated according to an audio model, wherein the audio model is based on the video data collected by the transmitting device (e.g., the device communicating with device 302 in the video communication session). In one or more examples, an audio model refers to a set of parameters or characteristics of the audio that can be changed/modified by processing the collected audio. For instance, as illustrated in FIG. 4A, the audio associated with the video data received by device 302 includes a first person audio volume parameter 402, an environment audio volume parameter 404, and one or more directionality parameters 406. As described in further detail below, each of parameters 402, 404, and 406 can be modified according to one or more detected changes in the video. In one or more examples, the parameters can be set/modified at the device collecting the audio, and the processed audio can be sent to device 302 to be emitted as part of the video communication session. Additionally or alternatively, the audio collected by the device can be transmitted to device 302, and device 302 can process the audio to set the parameters 402, 404, and 406 in accordance with video data associated with the video communication sessions, and used to render avatar 308a at device 302. Additionally or alternatively an intermediate device (such as a server) can receive the audio collected by the transmitting device, and process the audio in accordance with the examples above before transmitting the processed audio to the receiving device.

In one or more examples, the audio recorded by the device in communication with device 302 via the video communication session can include at least two components: a first person audio stream and an environment audio stream. In one or more examples, the first person audio stream can refer to the portion of the audio that is uttered or emitted by the user of the device that is collecting the audio. For instance, the first person audio stream can include the user's voice. In one or more examples, the environment audio stream can refer to the portion of the audio that is associated with the environment of the user (e.g., background audio). In one or more examples, the first person audio stream and the environment audio stream can be generated from a common audio stream. For instance, the transmitting device can collect audio using one or more microphones, and the first person audio stream and environment audio stream can be generated by filtering (e.g., using a band-pass filter centered on the expected frequency or range of frequencies of the user's voice or the expected range of frequencies of the environment audio, beamforming microphones toward or away from the user's mouth, etc.) the common audio stream to separate the first person audio stream and the environment audio stream. In some examples, in addition to the first person audio stream and the environment audio stream, the audio stream can also include one or more audio streams associated with other participants that are conversing or communicating as part of the video communication session. In some examples, the audio streams associated with other participants can be augmented and/or reduced in accordance with the examples provided herein with respect to the first person audio stream and the environment audio stream.

In one or more examples, the device can generate the audio (that includes both the first person audio stream and the environment audio stream) according to an audio model as described above. For instance, and as part of generating the audio according to an audio model, the device can set a volume/magnitude of the first person audio stream and the environment audio stream by setting/modifying first person volume parameter 402 and environment audio volume parameter 404. By adjusting the first person volume parameter 402 and/or the environment audio volume parameter, the device is able control the degree to which the first person audio is emphasized versus the environment audio. For instance, as depicted in FIG. 4A, the level/volume of first person volume parameter 402 is greater than the level/volume of environment audio volume parameter 404. Thus, in accordance with the setting of parameters 402 and 404 as described above, the user of device 302 will hear an audio stream associated with the video communications session that emphasizes the first person audio portion of the audio stream and deemphasizes (or eliminates) the environment audio portion of the audio stream.

In one or more examples, the setting of parameters 402, 404, and 406 can be based on the video stream/data that is being received at device 302 as part of the video communications session. For instance, in the example of FIG. 4A, in response to the video data transmitted from the device 304 (e.g., the transmitting device) device 302 optionally displays avatar 308a. In one or more examples, as the video data indicates that the user of the transmitting device intends to display an avatar or other visual representation of themselves, the first person audio volume parameter 402 can be set to be greater than the environment audio volume parameter 404, so as to emphasize the first person audio relative to the environment audio. The video data can correspond to one or more inward facing cameras or imaging devices that image user of device 304 (e.g., capturing information about movement of the eyes, mouth, face, torso, etc.). Because display of avatar 308a indicates that the user of the transmitting device 304 is likely speaking to the user of device 302, the audio that emitted in conjunction with the video emphasizes the first person audio and reduces (or minimizes or eliminates) the sound of the environment so that environmental sounds do not interfere with or drown out the voice of the person speaking to user 310 of device 302. In this way, the user 310 of device 302 can more efficiently listen to the audio associated with the user represented by avatar 308a.

In one or more examples, the first person audio volume parameter 402 and the environment audio volume parameter 404 can be modified based on changes in the received video as illustrated in FIG. 4B. In one or more examples, and as illustrated in FIG. 4B, instead of displaying an avatar, such as avatar 308a in FIG. 4A, instead the device 302 displays video 408 in response to a change in the video data transmitted from the device 304 with which device 302 is in communication with. For instance, when the user of the device 304 in communication with device 302 activates one or more outward facing cameras on their device (instead of transmitting video associated with the avatar 308a optionally based on one or more inward facing cameras) to show user 310 of device 302 the environment that they are currently viewing, in one or more examples, the device 302 can forgo displaying avatar 308 and instead display video 408 that is rendered based on video data (e.g., from the one or more outward facing cameras) being transmitted by the device 304. As illustrated in FIG. 4B, the user of the device 304 in communication with device 302 is attending a concert and wants to show user 310 of device 302 scenes from the concert. This is enabled, for example, while communicating with the user 310 of device 302 (e.g., via avatar 308a), when the user of device 304 switches the video stream to one or more cameras on device 304 that are pointing in the direction of the concert (e.g., activates one or more cameras on their device that are pointing in the direction of the concert), so that user 310 of device 302 can see a video of the concert at which they are not physically present.

In one or more examples, the audio stream associated with the video 408 can be modified according to an audio model that is based on the change in the received video. For instance in the example of FIG. 4B, because the user of the device 304 that is communicating with device 302 has changed the video to show the user 310 of device 302 a video of the environment of device 304 (e.g., instead of an avatar), the audio model can be modified to emphasize the environment audio stream and deemphasize the first person audio stream. For instance, as illustrated in FIG. 4B, in response to the change in video from avatar 308a to video 408, the first person audio volume parameter 402 is reduced and the environment audio volume parameter 404 is increased such that first person audio volume parameter 402 is less than the environment audio volume parameter 404. Additionally or alternatively, the environment audio volume parameter 404 can be increased without reducing the first person audio volume parameter such that the first person audio volume parameter 402 is less than the environment audio volume parameter 404. In this way, instead of emphasizing the user's voice, the device emphasizes the environment audio such that the user of device 302 can efficiently listen to the concert with minimal interference from the voice or breathing of the user of the device in communication with device 302. In one or more examples, and in the example of the audio being processed at the transmitting device in accordance with the audio model prior to being transmitted, the transmitting device can obtain an indication that one or more cameras (e.g., outward facing cameras, inward facing cameras, etc.) have been activated as part of the video communication session and can adjust the audio accordingly. In the example of the audio being processed at the receiving device as described above, the transmitting device can, in one or more examples, transmit metadata (e.g., regarding the type of cameras used to capture the video data) or append this metadata to the transmitted video data (in addition to transmitting the raw audio data), and the receiving device (e.g., device 302) can process the audio according to the audio model in response to detecting the metadata transmitted by the transmitting device.

In one or more examples, including or emphasizing the environment audio (e.g., by increasing environment audio parameter volume 404) can be implemented by purely processing the audio generated by the collecting device. For instance, the collected audio can be separated into the environment audio stream and the first person audio stream described above, and the magnitude (e.g., volume) of the environment audio stream can be amplified (or not attenuated). Additionally or alternatively, the in response to detecting that the one or more cameras of the device have been activated, the transmitting device can activate one or more additional microphones (or change one or more parameters associated with microphones that are already active such as changing a beam forming parameter) that are configured to collect environment audio so as to augment the environment audio stream. In one or more examples, the first person audio stream can be deemphasized (e.g., by reducing the first person audio volume parameter 402) by filtering out the first person audio component of the audio stream. For instance, a digital filter can be employed that is shaped such that the spectral elements associated with first person audio are degraded, while the spectral elements associated with the environment audio is allowed to pass through the filter with minimal degradation.

As illustrated in and described with reference to FIGS. 4A-4B, the audio parameters are adjusted based on the video. In one or more examples, the transition is instantaneous. For example, switching from outward to inward facing cameras causes immediate suppression or attenuation of environmental audio, whereas switching from inward to outward facing cameras causes emphasizes or amplifies or forgoes suppression of environmental audio. In one or more examples, the audio model can be gradually transitioned (e.g., the first person audio volume parameter 402 can be gradually reduced and/or the environment volume parameter 404 can be gradually increased) in response to detecting a change in the video rather than being changed abruptly. For example, the environmental audio can fade in when transitioning to outward facing cameras, whereas the environmental audio can fade out when transition to inward facing cameras.

In one or more examples, the audio model can also include a directionality parameter 406 as illustrated in FIG. 4B. In one or more examples, directionality parameter 406 can refer to the direction from which the audio sounds like it is coming from within three-dimensional environment 322 from the perspective of user 310 of device 302. For instance, as illustrated in FIG. 4B, the directionality parameter 406 is centered within the range of values, such that the audio being played at device 302 sounds like it is coming from directly in front of the user in accordance with the video 408 being played in front of and centered from the perspective of the user 310 of device 302. In one or more examples, and as described in further detail below, the directionality parameter 406 can be modified in accordance with detected changes in the video 408.

In one or more examples, video 408 can include an object of interest 410 (or a region of interest) as illustrated in FIG. 4B. In one or more examples, the object of interest can refer to an object (or a person) in the video that is identified as playing a significant role in the environment audio or a focus of the attention of user of device 304. For instance, in the example of the concert scene shown in video 408, the object of interest 410 includes the lead singer of the band playing the concert. In some examples, and as described below, the directionality parameter 406 of the audio model can be adjusted according to the position of the object of interest 410 within the video 408. In one or more examples, the object of interest can be identified by the user of the device in communication with device 302 as part of the video communication session. For instance, the gaze of the user or the pointing direction of device 304 can be used to detect the object of interest 410 within the video 408. For instance, if the gaze of the user (as tracked by the device of the user recording the video) is detected as being fixed on a particular object (or set of objects) within the video 408, then the object can be identified as the object of interest 410. Additionally or alternatively, the object of interest 410 can be automatically identified based on a machine learning classifier trained to detect objects of interest in video data. In the example of FIG. 4B, because the object of interest 410 is at the center of the video 408, the directionality parameter 406 is set so that the directionality of the audio is also centered from the viewpoint of the user 310 of device 302. Thus, the audio will be emitted to sound as if the audio is coming from directly in front of and to the center from the viewpoint of the user 310 of device 302.

In one or more examples, the directionality parameter 406 of the audio model can be modified in accordance with a change in the location of the object of interest 410 in video 408 as illustrated in FIG. 4C. In the example of FIG. 4C, the user of the transmitting device (e.g., the device in communication with device 302 as part of the video communications session) moves their body (e.g., by moving their head) so as to change the perspective of the video 408. As illustrated in FIG. 4C the user modifies their perspective to the left, such that the object of interest (e.g., the lead singer of the band) moves to the right within the video 408, even though the object of interest has not actually moved. Additionally or alternatively, the object of interest 410 can move within the video 408 without the user altering their viewpoint. In one or more examples, the transmitting device in response to detecting a change in the location of the object of interest 410 relative to the view of the user of the device, can modify the directionality of the audio by using one or more beam forming microphones, so that audio collection is in the direction of the object of interest 410, thereby emphasizing the portion of the environment audio associated with the object of interest 410. Additionally or alternatively, the audio as emitted at the user's device can be imparted with a directionality that matches the direction at which the object of interest appears in the video stream such that the audio sounds as if it is being emitted from the direction at which the object of interest is located.

In the example in which the transmitting device processes the audio to conform to an audio model, the device transmitting device can modify directionality parameter 406 such that when the audio is played at device 302, the audio will sound as if it is being emitted from the direction of the object of interest 410 within video 408. For instance, in contrast to the example of FIG. 4B, the directionality parameter 406 can be modified to the right (as shown in the figure) so that that the audio associated with video 408 sounds like the audio is coming from in front of and to the right of the user 310 of device 302. In the example, in which the receiving device (e.g., device 302) processes the audio to conform to an audio model, the transmitting device can indicate that the directionality of the audio has changed by transmitting directionality information as metadata along with the transmitted audio. For instance, the transmitting device can transmit the directionality information as an audio parameter that indicates the directionality of the object of interest. Additionally or alternatively, the receiving device uses the directionality information to set the directionality parameter. In accordance with the transmitted directionality information, the receiving device 302 can modify the directionality parameter 406 such that the environment audio sounds as if it is coming from the direction in which the object of interest 410 is located within video 408. In some examples, the metadata (e.g., the directionality information) can include information about the direction that the beam forming microphones of the transmitting device are pointed towards. In one or more examples, the receiving device 302 can modify directionality parameter 406 in response to detecting changes in the directionality information transmitted by the transmitting device.

In one or more examples, if the user of the transmitting device in communication with device 302 as part of the video communication session reverts back to transmitting an avatar 308a as in FIG. 4A, the audio model can revert back to the audio model illustrated in FIG. 4A (wherein the first person audio is emphasized while the environmental audio is deemphasized). In one or more examples, the audio model illustrated in FIG. 4A can be designated as a default audio model that can be used in instances when the video of the transmitting device is switched off (e.g., the user of the transmitting device does not wish to transmit any video either in the form of an avatar or of the environment of device 304) as illustrated in FIG. 4D. In the example of FIG. 4D, the user of the transmitting device has switched off their video (e.g., device ceases transmitting video when the user switched off the video or otherwise indicated that they do not wish to transmit video as part of the video communications session). In one or more examples, in response to the user of the transmitting device switching the video off, device 302 can display a representation 412 that includes an indication of the identity of the user and/or an image of the user (or the user's initials) as illustrated in FIG. 4D. In the example where the transmitting device processes the audio prior to transmitting it to the received device 302, the transmitting device can revert the audio model back to the default model, which for instance in the example of FIG. 4D is the same audio model used in FIG. 4A. Alternatively, in the example where the receiving device processes the audio to conform to the audio model, the receiving device 302 can process the received audio in accordance with the default audio model as illustrated by the change in parameters 402, 404, and 406 illustrated in FIG. 4D (which are at the same levels illustrated in FIG. 4A).

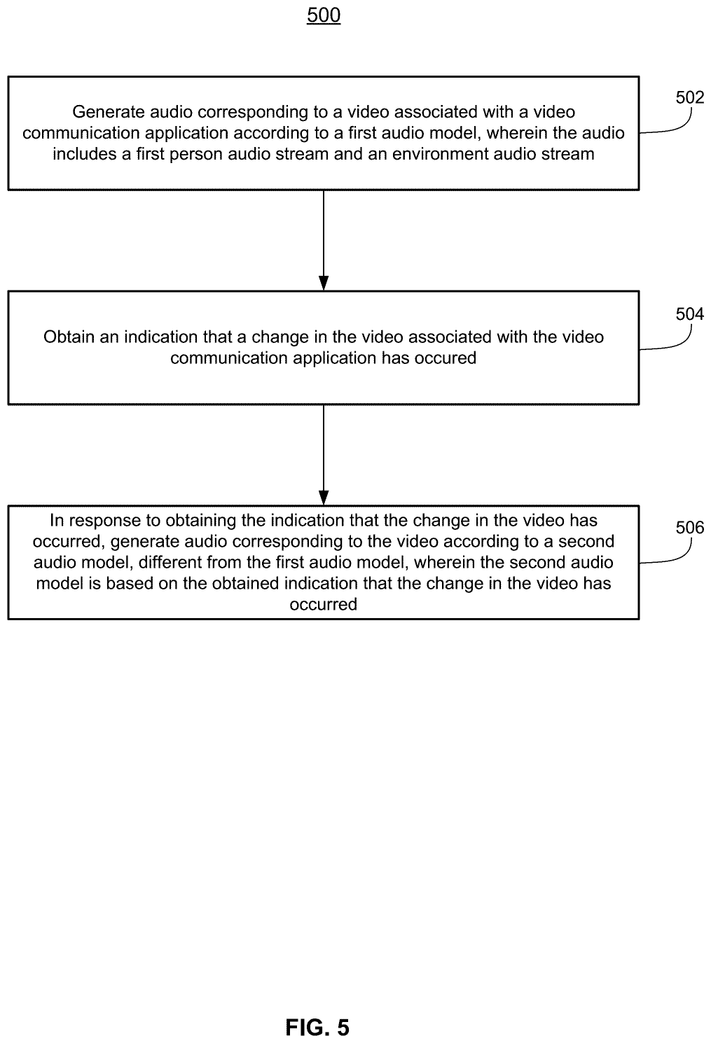

FIG. 5 illustrates an example flow diagram illustrating a method of presenting audio during a video communications session according to examples of the disclosure. In some examples, process 500 begins at an electronic device in communication with a display and one or more input devices. In some examples, the electronic device is optionally a head-mounted display similar or corresponding to device 201 of FIG. 2. As shown in FIG. 5, in one or more examples, at 502, the device (either the transmitting device or the receiving device as described above) generates audio corresponding to a video associated with a video communication application according to a first audio model, wherein the audio includes a first person audio stream and an environment audio stream. As described above with respect to FIGS. 4A-4D, the audio model includes parameters that when modified by a user or the device itself change one or more characteristics of the audio. For instance, and as described above with respect to FIG. 4B, the audio model can include a first person volume parameter, an environment audio volume parameter, and a directionality parameter. Each of the parameters can be modified according to an audio model, wherein the audio model is based on a detected state of the video being displayed during a video communication session. For instance, if the video being displayed as part of the video communications session is an avatar of a user (or a video of the user themselves) then the first audio model can include setting the parameters of the audio model such that the first person audio is emphasized while the environmental audio is deemphasized such as shown in FIG. 4A.

In one or more examples, at 502, the device (either the transmitting device or the receiving device as described above) obtains an indication, at 504, that a change in the video associated with the video communication application has occurred. For instance, as described above with respect to FIG. 4B, either the transmitting device or the receiving device can detect that the one or more outward facing cameras have been activated as part of the video communications session. Additionally or alternatively, either the receiving or the transmitting device can detect an object of interest such as object of interest 410 in FIGS. 4B and 4C, and can detect changes in the location of the object of interest as described above with respect to object of interest 410 of FIG. 4D.

In one or more examples, in response to obtaining the indication that the change in the video has occurred, the device (either the receiving device or the transmitting device) generates audio corresponding to the video according to a second audio model, different from the first audio model, wherein the second audio model is based on the obtained indication that the change in the video has occurred. In one or more examples, in response to detecting that one or more outward facing cameras have been activated as part of the video communications session, the device (either the receiving device or the transmitting device) can modify the parameters associated with an audio model to conform to a second audio model, wherein the second audio model is configured to emphasize the environment audio stream and deemphasize the first person audio as described above with respect to parameters 402, 404, and 406 of FIG. 4B. Additionally or alternatively, in response to detecting a change in the location of a detected object of interest in the video, the device (either the receiving device or the transmitting device) can modify a directionality of the audio (e.g., modify parameter 406 as discussed above with respect to FIG. 4C) so that audio emitted at the user's device (e.g., the receiving device) sounds as if it coming from the direction in the video that the object of interest in located within the three-dimensional environment being displayed by the receiving device.

It is understood that process 500 is an example and that more, fewer, or different operations can be performed in the same or in a different order. Additionally, the operations in process 500 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method, comprising at a computer system: generating audio corresponding to a video associated with a video communication application according to a first audio model, wherein the audio includes a first person audio stream and an environment audio stream, obtaining an indication that a change in the video associated with the video communication application has occurred, and in response to obtaining the indication that the change in the video has occurred, generating audio corresponding to the video according to a second audio model, different from the first audio model, wherein the second audio model is based on the obtained indication that the change in the video has occurred.

Optionally, the first audio model includes generating the first person audio stream at a first level, wherein the first audio model includes generating the environment audio stream at a second level, wherein the second audio model includes generating the first person audio stream at a third level that is less than the first level, and wherein the second audio model includes generating the environment audio stream at a fourth level that is greater than the second level.

Optionally, the first person audio stream at the third level that is less than the first level according to the second audio model includes applying a filter to the first person audio stream of the audio associated with the video communication application.

Optionally, generating the environment audio stream at the fourth level that is greater than the second level according to the second audio model is generated by activating one or more microphones communicatively coupled to a computer system recording the audio stream, wherein the one or more microphones are configured to capture audio from an environment of a user of the computer system.

Optionally, obtaining the indication that a change in the displayed video has occurred comprises obtaining an indication of activation of one or more cameras communicatively coupled to a computer system recording the video associated with the video communication application.

Optionally, the one or more cameras that are communicatively coupled to the computer system recording the video associated with the video communication application comprise one or more outward facing cameras.

Optionally, obtaining the indication that a change in the video has occurred comprises obtaining an indication that the displayed video includes a first object.

Optionally, the first audio model includes one or more first directionality parameters, wherein the second audio model comprises one or more second directionality parameters different from the one or more first directionality parameters, and wherein the method further comprises: in response to obtaining the indication that the change in the video has occurred, generating audio associated with the video according to the one or more second directionality parameters.

Optionally, the one or more second directionality parameters are based on a location of the first object within the video.

Optionally, the first person audio stream includes one or more directionality parameters, and wherein the one or more directionality parameters are configured to cause the audio associated with the video to be presented as if the audio is being emitted from in front of a user receiving the presented audio.

Optionally, the first audio model is a default audio model, and wherein the method further comprises: obtaining one or more parameters from the user of the computer system, and configuring the default audio model according to the one or more parameters from the user of the computer system.

Optionally, the method further comprises: obtaining an indication of ceasing capture or display of the video, and in response to obtaining the indication of ceasing capture or display of the video, generating the audio corresponding to the video according to the default audio model.

Optionally, the method further comprises: in response to obtaining the indication that the change in the video has occurred: transitioning the presented audio associated with the video from the first audio model to the second audio model.

Therefore, according to the above, some examples of the disclosure are directed to a method comprising: at a computer system: obtaining video and audio information from a transmitting device, wherein the obtained video and audio information are associated with a video communication application, generating audio corresponding to the obtained video and obtained audio information associated with the video communication application according to a first audio model, wherein the generated audio includes a first person audio stream and an environment audio stream, obtaining an indication that a change in the video associated with the video communication application has occurred, and in response to obtaining the indication that the change in the video has occurred, generating audio corresponding to the video according to a second audio model, different from the first audio model, wherein the second audio model is based on the obtained indication that the change in the video has occurred.

Optionally, the first audio model includes generating the first person audio stream at a first level, wherein the first audio model includes generating the environment audio stream at a second level, wherein the second audio model includes generating the first person audio stream at a third level that is less than the first level, and wherein the second audio model includes generating the environment audio stream at a fourth level that is greater than the second level.

Optionally, generating the first person audio stream at the third level that is less than the first level according to the second audio model includes applying a filter to the first person audio stream of the audio associated with the video communication application.

Optionally, generating the environment audio stream at the fourth level that is greater than the second level according to the second audio model is generated by activating one or more microphones communicatively coupled to a computer system recording the audio stream, wherein the one or more microphones are configured to capture audio from an environment of a user of the computer system.

Optionally, obtaining the indication that a change in the displayed video has occurred comprises obtaining an indication that one or more cameras of the transmitting device have been activated.

Optionally, the one or more cameras of the transmitting device comprise one or more outward facing cameras.

Optionally, obtaining the indication that a change in the obtained video has occurred comprises obtaining an indication that the obtained video includes a first object.

Optionally, the first audio model includes one or more first directionality parameters, wherein the second audio model comprises one or more second directionality parameters different from the one or more first directionality parameters, and wherein the method further comprises: in response to obtaining the indication that the change in the obtained video has occurred, generating audio associated with the video according to the one or more second directionality parameters.

Optionally, the one or more second directionality parameters are based on a location of the first object within the obtained video.

Optionally, the first person audio stream includes one or more directionality parameters, and wherein the one or more directionality parameters are configured to cause the audio associated with the video to be presented as if the audio is being emitted from in front of a user hearing the presented audio.

Optionally, the first audio model is a default audio model, and wherein the method further comprises: obtaining one or more parameters from the user of the computer system, and configuring the default audio model according to the one or more parameters from the user of the computer system.

Optionally, method further comprises: obtaining an indication of ceasing capture or display of the video, and in response to obtaining the indication of ceasing capture or display of the video, generating the audio corresponding to the video according to the default audio model.

Optionally, the method further comprises: in response to obtaining the indication that the change in the video has occurred: gradually transitioning the presented audio associated with the video from the first audio model to the second audio model.

Therefore, according to the above, some examples of the disclosure are directed to a method comprising: at a computer system: generating audio corresponding to a video associated with a video communication application according to a first audio model, wherein the audio includes a first person audio stream and an environment audio stream, transmitting the generated audio according to the first model to a receiving device in communication with the computer system, obtaining an indication that a change in the video associated with the video communication application has occurred, in response to obtaining the indication that the change in the video has occurred, generating the audio corresponding to the video according to a second audio model, different from the first audio model, wherein the second audio model is based on the obtained indication that the change in the video has occurred, and transmitting the audio corresponding to the video generated according to the second model to the receiving device in communication with the computer system.

Optionally, the first audio model includes generating the first person audio stream at a first level, wherein the first audio model includes generating the environment audio stream at a second level, wherein the second audio model includes generating the first person audio stream at a third level that is less than the first level, and wherein the second audio model includes generating the environment audio stream at a fourth level that is greater than the second level.

Optionally, generating the first person audio stream at the third level that is less than the first level according to the second audio model includes applying a filter to the first person audio stream of the audio associated with the video communication application.

Optionally, the generating the environment audio stream at the fourth level that is greater than the second level according to the second audio model is generated by activating one or more microphones communicatively coupled to a computer system recording the audio stream, wherein the one or more microphones are configured to capture audio from an environment of a user of the computer system.

Optionally, obtaining the indication that a change in the displayed video has occurred comprises obtaining an indication that one or more cameras communicatively coupled to a computer system recording the video associated with the video communication application have been activated.

Optionally, the one or more cameras that are communicatively coupled to the computer system recording the video associated with the video communication application comprise one or more outward facing cameras.

Optionally, obtaining the indication that a change in the video has occurred comprises obtaining an indication that the displayed video includes a first object.

Optionally, the first audio model includes one or more first directionality parameters, wherein the second audio model comprises one or more second directionality parameters different from the one or more first directionality parameters, and wherein the method further comprises: in response to obtaining the indication that the change in the video has occurred, generating audio associated with the video according to the one or more second directionality parameters.

Optionally, the one or more second directionality parameters are based on a location of the first object within the video.

Optionally, the method further comprises operating one or more beam forming microphones communicative coupled to a computer system that is recording the video based on the one or more second directionality parameters.

Optionally, the first person audio stream includes one or more directionality parameters, and wherein the one or more directionality parameters are configured to cause the audio associated with the video to be presented as if the audio is being emitted from in front of a user receiving the presented audio.

Optionally, the first audio model is a default audio model, and wherein the method further comprises: obtaining one or more parameters from the user of the computer system, and configuring the default audio model according to the one or more parameters from the user of the computer system.

Optionally, the method further comprises: obtaining an indication of ceasing capture or display of the video, and in response to obtaining the indication of ceasing capture or display of the video, generating the audio corresponding to the video according to the default audio model.

Optionally, the method further comprises: in response to obtaining the indication that the change in the video has occurred: gradually transitioning the presented audio associated with the video from the first audio model to the second audio model.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at a computer system:
generating audio corresponding to a video associated with a video communication application according to a first audio model, wherein the audio includes a first person audio stream and an environment audio stream;
obtaining an indication that a change in the video associated with the video communication application has occurred; and
in response to obtaining the indication that the change in the video has occurred, generating audio corresponding to the video according to a second audio model, different from the first audio model, wherein the second audio model is based on the obtained indication that the change in the video has occurred.

2. The method of claim 1, wherein the first audio model includes generating the first person audio stream at a first level, wherein the first audio model includes generating the environment audio stream at a second level, wherein the second audio model includes generating the first person audio stream at a third level that is less than the first level, and wherein the second audio model includes generating the environment audio stream at a fourth level that is greater than the second level.

3. The method of claim 2, wherein the generating the environment audio stream at the fourth level that is greater than the second level according to the second audio model is generated by activating one or more microphones communicatively coupled to a computer system recording the audio stream, wherein the one or more microphones are configured to capture audio from an environment of a user of the computer system.

4. The method of claim 1, wherein obtaining the indication that a change in the video has occurred comprises obtaining an indication that the displayed video includes a first object.

5. The method of claim 4, wherein the first audio model includes one or more first directionality parameters, wherein the second audio model comprises one or more second directionality parameters different from the one or more first directionality parameters, and wherein the method further comprises:
in response to obtaining the indication that the change in the video has occurred, generating audio associated with the video according to the one or more second directionality parameters.

6. The method of claim 1, wherein the first person audio stream includes one or more directionality parameters, and wherein the one or more directionality parameters are configured to cause the audio associated with the video to be presented as if the audio is being emitted from in front of a user receiving the presented audio.

7. The method of claim 1, wherein obtaining the indication that a change in the displayed video has occurred comprises obtaining an indication of activation of one or more cameras communicatively coupled to a computer system recording the video associated with the video communication application.

8. The method of claim 1, wherein the method further comprises:
in response to obtaining the indication that the change in the video has occurred: transitioning the presented audio associated with the video from the first audio model to the second audio model.

9. An electronic device comprising:
one or more processors;
memory; and
one or more programs stored in the memory and configured to be executed by the one or more processors, the one or more programs including instructions for:
generating audio corresponding to a video associated with a video communication application according to a first audio model, wherein the audio includes a first person audio stream and an environment audio stream;
obtaining an indication that a change in the video associated with the video communication application has occurred; and
in response to obtaining the indication that the change in the video has occurred, generating audio corresponding to the video according to a second audio model, different from the first audio model, wherein the second audio model is based on the obtained indication that the change in the video has occurred.

10. The electronic device of claim 9, wherein the first audio model includes generating the first person audio stream at a first level, wherein the first audio model includes generating the environment audio stream at a second level, wherein the second audio model includes generating the first person audio stream at a third level that is less than the first level, and wherein the second audio model includes generating the environment audio stream at a fourth level that is greater than the second level.

11. The electronic device of claim 10, wherein the generating the environment audio stream at the fourth level that is greater than the second level according to the second audio model is generated by activating one or more microphones communicatively coupled to a computer system recording the audio stream, wherein the one or more microphones are configured to capture audio from an environment of a user of the computer system.

12. The electronic device of claim 10, wherein obtaining the indication that a change in the video has occurred comprises obtaining an indication that the displayed video includes a first object.

13. The electronic device of claim 12, wherein the first audio model includes one or more first directionality parameters, wherein the second audio model comprises one or more second directionality parameters different from the one or more first directionality parameters, and wherein the one or more programs include further instructions for:
in response to obtaining the indication that the change in the video has occurred, generating audio associated with the video according to the one or more second directionality parameters.

14. The electronic device of claim 9, wherein the first person audio stream includes one or more directionality parameters, and wherein the one or more directionality parameters are configured to cause the audio associated with the video to be presented as if the audio is being emitted from in front of a user receiving the presented audio.

15. The electronic device of claim 9, wherein obtaining the indication that a change in the displayed video has occurred comprises obtaining an indication of activation of one or more cameras communicatively coupled to a computer system recording the video associated with the video communication application.

16. The electronic device of claim 9, wherein the one or more programs include further instructions for:
in response to obtaining the indication that the change in the video has occurred: transitioning the presented audio associated with the video from the first audio model to the second audio model.

17. A non-transitory computer readable storage medium storing one or more programs, the one or more programs comprising instructions, which when executed by one or more processors of an electronic device, cause the electronic device to perform a method comprising:
at a computer system:
generating audio corresponding to a video associated with a video communication application according to a first audio model, wherein the audio includes a first person audio stream and an environment audio stream;
obtaining an indication that a change in the video associated with the video communication application has occurred; and
in response to obtaining the indication that the change in the video has occurred, generating audio corresponding to the video according to a second audio model, different from the first audio model, wherein the second audio model is based on the obtained indication that the change in the video has occurred.

18. The non-transitory computer readable storage medium of claim 17, wherein the first audio model includes generating the first person audio stream at a first level, wherein the first audio model includes generating the environment audio stream at a second level, wherein the second audio model includes generating the first person audio stream at a third level that is less than the first level, and wherein the second audio model includes generating the environment audio stream at a fourth level that is greater than the second level.

19. The non-transitory computer readable storage medium of claim 18, wherein the generating the environment audio stream at the fourth level that is greater than the second level according to the second audio model is generated by activating one or more microphones communicatively coupled to a computer system recording the audio stream, wherein the one or more microphones are configured to capture audio from an environment of a user of the computer system.

20. The non-transitory computer readable storage medium of claim 18, wherein obtaining the indication that a change in the video has occurred comprises obtaining an indication that the displayed video includes a first object.

21. The non-transitory computer readable storage medium of claim 20, wherein the first audio model includes one or more first directionality parameters, wherein the second audio model comprises one or more second directionality parameters different from the one or more first directionality parameters, and wherein the one or more programs include further instructions for:
in response to obtaining the indication that the change in the video has occurred, generating audio associated with the video according to the one or more second directionality parameters.

22. The non-transitory computer readable storage medium of claim 17, wherein the first person audio stream includes one or more directionality parameters, and wherein the one or more directionality parameters are configured to cause the audio associated with the video to be presented as if the audio is being emitted from in front of a user receiving the presented audio.

23. The non-transitory computer readable storage medium of claim 17, wherein obtaining the indication that a change in the displayed video has occurred comprises obtaining an indication of activation of one or more cameras communicatively coupled to a computer system recording the video associated with the video communication application.

24. The non-transitory computer readable storage medium of claim 17, wherein the one or more programs include further instructions for:
in response to obtaining the indication that the change in the video has occurred: transitioning the presented audio associated with the video from the first audio model to the second audio model.
